(19) United States
(12) Patent Application Publication
(10) Pub. No.: US 2024/0384084 A1
(43) Pub. Date: Nov. 21, 2024

(54) ECO-FRIENDLY ERASER USING EPDM RUBBER

(71) Applicant: Yeungnam University Industry-Academic Cooperation Foundation, Gyeongsan-si (KR)

(72) Inventors: Seong Cheol KIM, Gyeongsan-si (KR); SHAKILA PARVEEN ASRAF ALI, Gyeongsan-si (KR)

(73) Assignee: Yeungnam University Industry-Academic Cooperation Foundation, Gyeongsan-si (KR)

(21) Appl. No.: 18/664,263

(22) Filed: May 14, 2024

(30) Foreign Application Priority Data
May 15, 2023 (KR) 10-2023-0062580
Nov. 21, 2023 (KR) 10-2023-0162216

(51) Int. Cl. C08L 23/16; B43L 19/00; C08K 3/26; C08L 23/22

(52) U.S. Cl. CPC C08L 23/16; B43L 19/0025; C08K 3/26; C08L 23/22; C08K 2003/265; C08L 2205/02

(57) ABSTRACT

The present invention relates to an eco-friendly eraser using EPDM rubber, and more specifically, to an eraser composition containing EPDM (ethylene-propylene-diene monomer), a plasticizer, and calcium carbonate, and to an eco-friendly eraser containing the same. The present invention can provide an eco-friendly eraser that does not require a vulcanization process, does not use low-molecular-type plasticizers, and has excellent erasing properties, hardness, and color, and can replace PVC erasers.

### TECHNICAL FIELD

The present invention relates to an eco-friendly eraser using EPDM rubber, and more specifically, to an eraser composition containing EPDM (ethylene-propylene-diene monomer), a plasticizer, and calcium carbonate, and to an eco-friendly eraser containing the same.

### BACKGROUND ART

The use of existing erasers using PVC is gradually decreasing due to the toxicity of plasticizers contained in PVC and hydrogen chloride generated during the decomposition process of PVC.

As a material to replace PVC erasers, cross-linked erasers made of natural rubber or butadiene are used. The eraser turns yellow due to sulfur used as a cross-linking agent, so a colorant is needed. In addition, there is a problem in that hardness increases rapidly as it turns brown due to oxidation and hardening of sulfur.

Erasers using SBR contain styrene, which acts as an environmental hormone, and must use a low-molecular-weight plasticizer. In addition, toxic substances may be generated during the decomposition process of erasers.

Therefore, there is a need to develop technology for an eco-friendly eraser that does not require a vulcanization process, does not use low-molecular-weight plasticizers, has excellent erasing properties, hardness, and color, and can replace PVC erasers.

(Patent Document 1) Korean Patent Publication No. 10-2009-0107637

### SUMMARY OF INVENTION

### Technical Problem

The present invention was developed to solve the above problems, and provides an eco-friendly eraser that does not require a vulcanization process, does not use low-molecular-type plasticizers, has excellent erasing properties, hardness, and color, and can replace PVC erasers.

### Solution to Problem

In order to achieve the above object, the present invention provides a composition for an eraser containing EPDM (ethylene-propylene-diene monomer), a plasticizer, and calcium carbonate.

In one embodiment of the present invention, the composition contains 10 to 35% by weight of EPDM, 5 to 25% by weight of plasticizer, and 50 to 80% by weight of calcium carbonate.

In one embodiment of the present invention, the EPDM is characterized by a diene content of 0 to 10% by weight and an ethylene content of 50% by weight or more.

In one embodiment of the present invention, the plasticizer is one or more selected from phthalate, paraffin oil, mineral oil, petroleum oil, vulcanized vegetable oil, animal and vegetable oil, polyisobutylene, polyisoprene, and polybutadiene.

In one embodiment of the present invention, the composition further comprises one or more hardness regulators selected from polyethylene, polypropylene, polyisobutylene, polystyrene, and polyalphaolefin.

In one embodiment of the present invention, the composition further comprises one or more fillers selected from silica, zinc oxide, iron oxide, titanium dioxide, talc, graphite, alumina, activated carbon, and clay.

In addition, the present invention provides an eraser comprising the eraser composition.

### Advantageous Effects of Invention

The present invention was developed to solve the above problems, and provides an eco-friendly eraser that does not require a vulcanization process, does not use low-molecular-type plasticizers, and has excellent erasing properties, hardness, and color, and can replace PVC erasers.

### BRIEF DESCRIPTION OF DRAWINGS

FIG. 1 shows the erasing characteristics of the eraser in Example 1 of the present invention.

FIG. 2 shows the erasing characteristics of the eraser of Example 2 of the present invention.

### DESCRIPTION OF EMBODIMENTS

The present invention will be described in detail below based on examples. The terms, examples, etc. used in the present invention are merely illustrative to explain the present invention in more detail and aid the understanding of those skilled in the art, and the scope of rights of the present invention should not be construed as limited thereto.

Technical terms and scientific terms used in the present invention, unless otherwise defined, represent meanings commonly understood by those skilled in the art in the technical field to which this invention pertains.

The present invention relates to a composition for an eraser comprising EPDM (ethylene-propylene-diene monomer), a plasticizer, and calcium carbonate.

The composition may include 10 to 35% by weight of EPDM, 5 to 25% by weight of plasticizer, and 50 to 80% by weight of calcium carbonate.

In addition, the EPDM preferably has a diene content of 0 to 10% by weight and an ethylene content of 50% by weight or more.

Additionally, it is preferable that the EPDM is a non-crosslinked random copolymer.

As an example, the present invention relates to a composition for an eraser comprising EPDM (ethylene-propylene-diene monomer), a plasticizer, and calcium carbonate.

The composition may include 10 to 35% by weight of EPDM, 6 to 25% by weight of plasticizer, and 50 to 80% by weight of calcium carbonate.

The EPDM (ethylene-propylene-diene monomer) rubber does not require a vulcanization process, does not use low-molecular-type plasticizers, and has excellent erasing properties, hardness, and color, so it can replace PVC erasers.

The content of EPDM is preferably 10 to 35% by weight, and when the content satisfies the above numerical range, the erasing properties, hardness, and color can be maximized.

The EPDM preferably has a diene content of 10% by weight or less, and more preferably 5 to 9% by weight. If the content satisfies the above numerical range, the erasing properties, hardness, and color can be maximized.

In addition, the EPDM preferably has an ethylene content of 50% by weight or more, and when the content satisfies the above numerical range, the erasing properties, hardness, and color can be maximized.

As an example, the present invention relates to a composition for an eraser comprising EPM (ethylene-propylene monomer), a plasticizer, and calcium carbonate.

The composition may include 10 to 35% by weight of EPM, 5 to 25% by weight of plasticizer, and 50 to 70% by weight of calcium carbonate.

The EPM (ethylene-propylene monomer) rubber does not require a vulcanization process, does not use low-molecular-weight plasticizers, and has excellent erasing properties, hardness, and color, so it can replace PVC erasers.

The content of the EPM is preferably 10 to 35% by weight, and when the content satisfies the above numerical range, the erasing properties, hardness, and color can be maximized.

In addition, the EPM preferably has an ethylene content of 60% by weight or more, and more preferably 70% by weight or more. If the content satisfies the above numerical range, the erasing properties, hardness, and color can be maximized.

In addition, the EPM preferably has a propylene content of 60% by weight or more, and more preferably 70% by weight or more. If the content satisfies the above numerical range, the erasing properties, hardness, and color can be maximized.

In addition, the melting point of the EPM is preferably 70° C. or higher, and when the melting point satisfies the above numerical range, the erasing properties, hardness, and color can be maximized.

The plasticizer may be one or more selected from phthalate, paraffin oil, mineral oil, petroleum oil, vulcanized vegetable oil, animal and vegetable oil, polyisobutylene, polyisoprene, and polybutadiene, and it is desirable that polyisobutylene is used.

The phthalates include di-2-ethylhexyl phthalate (DEHP), dibutyl phthalate (DBP), diisodecyl phthalate (DIDP), butylbenzyl phthalate (BBP), diisononyl phthalate (DINP), and di-n-octyl phthalate (DNOP), etc.

Examples of the animal and vegetable oils include rapeseed oil, castor oil, cottonseed oil, linseed oil, soybean oil, sesame oil, corn oil, safflower oil, palm oil, rosin, and tall oil.

The content of the plasticizer is preferably 5 to 25% by weight, and when the content satisfies the above numerical range, the erasing properties, hardness, and color can be maximized.

In the present invention, it is preferable to use polyisobutylene as a plasticizer, and the number average molecular weight of polyisobutylene is preferably 300 to 1,500 g/mol.

In addition, the present invention includes polyisobutylene having a number average molecular weight of 300 to 800 g/mol (first polyisobutylene); and polyisobutylene having a number average molecular weight of 1,000 to 1,500 g/mol (second polyisobutylene) as a plasticizer.

At this time, the weight ratio of the first polyisobutylene and the second polyisobutylene is preferably 30 to 70:70 to 30, and when the weight ratio satisfies the above numerical range, the erasing properties, hardness and color can be maximized.

Additionally, the present invention can use a mixture of polyisobutylene and paraffin oil as a plasticizer.

At this time, the weight ratio of polyisobutylene and paraffin oil is preferably 70 to 90:10 to 30, and when the weight ratio satisfies the above numerical range, erasing properties, hardness and color can be maximized.

In addition, the present invention can use a mixture of polyisobutylene, paraffin oil, and animal and vegetable oil as a plasticizer.

At this time, the weight ratio of polyisobutylene, paraffin oil, and animal and vegetable oil is preferably 100:10 to 30:2 to 15, and when the weight ratio satisfies the above numerical range, the erasing properties, hardness, and color can be maximized.

The content of the calcium carbonate is preferably 50 to 70% by weight, and when the content satisfies the above numerical range, the removal properties, hardness, and color can be maximized.

Additionally, the composition may further include one or more hardness regulators selected from polyethylene, polypropylene, polyisobutylene, polystyrene, and polyalphaolefin.

The content of the hardness regulator is preferably 1 to 10% by weight, and when the content satisfies the above numerical range, the erasing properties, hardness and color can be maximized.

Additionally, the present invention can use a mixture of polyethylene and polypropylene as a hardness regulator.

At this time, the weight ratio of polyethylene and polypropylene is preferably 70 to 90:10 to 30, and when the weight ratio satisfies the above numerical range, the erasing properties, hardness and color can be maximized.

In addition, the present invention can be use a mixture of polyethylene, polypropylene, and polystyrene as a hardness regulator.

At this time, the weight ratio of polyethylene, polypropylene and polystyrene is preferably 100:10 to 30:2 to 15, and when the weight ratio satisfies the above numerical range, the erasing properties, hardness and color can be maximized.

Additionally, the composition may further include EPDM (ethylene-propylene-diene monomer).

The content of EPDM is preferably 1 to 35% by weight, and when the content satisfies the above numerical range, the erasing properties, hardness, and color can be maximized.

In addition, the composition may further include one or more fillers selected from silica, zinc oxide, iron oxide, titanium dioxide, talc, graphite, alumina, activated carbon, and clay.

The content of the filler is preferably 1 to 10% by weight, and when the content satisfies the above numerical range, the erasing properties, hardness, and color can be maximized.

Additionally, the present invention relates to an eraser comprising the eraser composition.

The present invention can provide an eco-friendly eraser that does not require a vulcanization process, does not use low-molecular-type plasticizers, has excellent erasing properties, hardness, and color, and can replace PVC erasers.

The present invention will be described in detail below through examples. The following examples are merely illustrative for carrying out the present invention, and the content of the present invention is not limited by the following examples.

### Example 1

An eraser composition was prepared by mixing 16% by weight of EPDM, 17% by weight of polyisobutylene, and 67% by weight of calcium carbonate at 120° C.

At this time, the ethylene content of EPDM was 70% by weight, and the diene content was 6.7% by weight.

Additionally, the number average molecular weight of polyisobutylene was adjusted to 1,200 g/mol.

The composition was molded in a Teflon mold, then immersed in cold water and slowly cooled to prepare an eraser. After being stored at room temperature for one week, the physical and erasing properties of the eraser were measured.

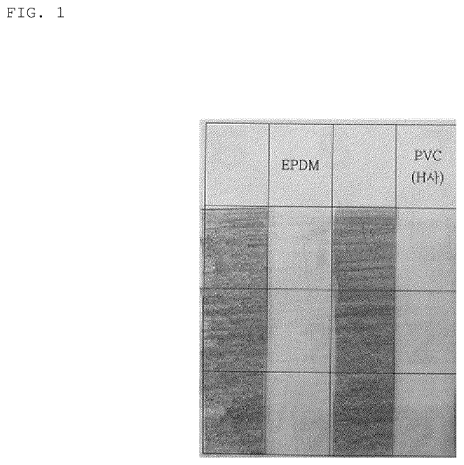

FIG. 1 shows the erasing characteristics of the eraser of the present invention.

It can be confirmed that the eraser of the present invention exhibits equivalent or better erasing properties compared to existing PVC erasers.

### Example 2

An eraser composition was prepared by mixing 29% by weight of EPM, 8% by weight of polyisobutylene, and 63% by weight of calcium carbonate at 180° C.

At this time, the ethylene content of EPM was adjusted to 70% by weight.

Additionally, the number average molecular weight of polyisobutylene was adjusted to 1,200 g/mol.

The composition was molded in a Teflon mold, then immersed in cold water and slowly cooled to prepare an eraser. After being stored at room temperature for one week, the physical and erasing properties of the eraser were measured.

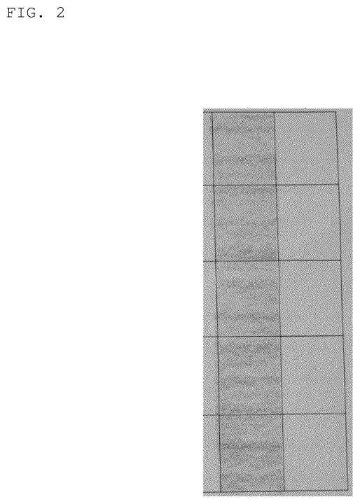

FIG. 2 shows the erasing characteristics of the eraser of the present invention.

It can be confirmed that the eraser of the present invention exhibits equivalent or better erasing properties compared to existing PVC erasers.

### Example 3

An eraser was manufactured in the same manner as Example 2, except that 29% by weight of EPM, 3% by weight of polyisobutylene, and 68% by weight of calcium carbonate were used.

### Example 4

An eraser was manufactured in the same manner as in Example 2, except that 29% by weight of EPM, 30% by weight of polyisobutylene, and 41% by weight of calcium carbonate were used.

### Example 5

An eraser was manufactured in the same manner as Example 2, except that EPM with an ethylene content of 55% by weight was used.

### Example 6

An eraser was manufactured in the same manner as in Example 2, except that polyisobutylene with a number average molecular weight of 200 g/mol was used.

### Example 7

An eraser was manufactured in the same manner as in Example 2, except that polyisobutylene with a number average molecular weight of 1,800 g/mol was used.

### Example 8

An eraser was manufactured in the same manner as in Example 2, except that a mixture of first polyisobutylene with a number average molecular weight of 500 g/mol and second polyisobutylene with a number average molecular weight of 1,200 g/mol was used.

At this time, the weight ratio of the first polyisobutylene and the second polyisobutylene was adjusted to 50:50.

### Example 9

An eraser was manufactured in the same manner as in Example 2, except that instead of 8% by weight polyisobutylene, a mixture of 6% by weight polyisobutylene and 2% by weight paraffin oil was used.

### Example 10

An eraser was manufactured in the same manner as in Example 2, except that 24% by weight of EPM, 8% by weight of polyisobutylene, 63% by weight of calcium carbonate, and 5% by weight of polyethylene were used.

### Comparative Example 1

An existing PVC eraser was used.

The properties of the erasers manufactured in the examples and comparative examples were measured and shown in Table 1.

### (Erase Characteristics)

The eraser test piece is placed perpendicular to the colored paper and is contacted at a right angle to the colored line. A weight is placed on the test piece so that the sum of the masses of the weight and the holder is 0.5 kg, and the test piece with a weight rubs the colored part back and forth four times at a speed of 150 cm/min.

Erasing properties were calculated by measuring the concentrations of the colored part and the friction removal part using a densitometer.

TABLE 1

| | erase | | |
|---|---|---|---|
| | characteristics | | |
| | (%) | hardness | color |
| Example 1 | 92 | 60 | white |
| Example 2 | 93 | 60 | white |
| Example 3 | 84 | 65 | white |
| Example 4 | 83 | 65 | white |
| Example 5 | 84 | 65 | white |
| Example 6 | 82 | 60 | white |
| Example 7 | 84 | 65 | white |
| Example 8 | 95 | 60 | white |
| Example 9 | 95 | 60 | white |
| Example 10 | 96 | 65 | white |
| Comparative | 87 | 65 | white |
| Example 1 | | | |

As can be seen in Table 1, Examples 1 to 10 were found to have excellent erasing properties, hardness, and color. In particular, Examples 1, 2, 8 to 10 have the best properties and exhibit properties equivalent to or better than those of existing PVC erasers.

On the other hand, it can be confirmed that the characteristics of Comparative Example 1 are inferior to those of the Example.

1. A composition for an eraser comprising EPDM (ethylene-propylene-diene monomer), a plasticizer, and calcium carbonate.

2. The composition for an eraser according to claim 1,
wherein the composition comprises 10 to 35% by weight of EPDM, 5 to 25% by weight of plasticizer, and 50 to 80% by weight of calcium carbonate.

3. The composition for an eraser according to claim 2,
wherein the diene content of EPDM is 0 to 10% by weight and the ethylene content or EPDM is 50% by weight or more.

4. The composition for an eraser according to claim 3,
wherein the plasticizer is one or more selected from phthalate, paraffin oil, mineral oil, petroleum oil, vulcanized vegetable oil, animal and vegetable oil, polyisobutylene, polyisoprene, and polybutadiene.

5. The composition for an eraser according to claim 1,
wherein the composition further comprises one or more hardness regulators selected from polyethylene, polypropylene, polyisobutylene, polystyrene, and polyalphaolefin.

6. The composition for an eraser according to claim 1,
wherein the composition further comprises one or more fillers selected from silica, zinc oxide, iron oxide, titanium dioxide, talc, graphite, alumina, activated carbon and clay.

7. An eraser comprising the composition for an eraser of claim 1.

8. An eraser comprising the composition for an eraser of claim 2.

9. An eraser comprising the composition for an eraser of claim 3.

10. An eraser comprising the composition for an eraser of claim 4.

11. An eraser comprising the composition for an eraser of claim 5.

12. An eraser comprising the composition for an eraser of claim 6.
